(19) United States
(12) Patent Application Publication
(10) Pub. No.: US 2009/0299929 A1
(43) Pub. Date: Dec. 3, 2009

(54) Methods of improved learning in simultaneous recurrent neural networks

(76) Inventors: Robert Kozma, Memphis, TN (US); Paul J. Werbos, Arlington, VA (US)

Correspondence Address: EDWARDS ANGELL PALMER & DODGE LLP, P.O. BOX 55874, BOSTON, MA, 02205, US

(21) Appl. No.: 12/156,164

(22) Filed: May 30, 2008

(51) Int. Cl. G06N 3/08

(52) U.S. Cl. 706/25

(57) ABSTRACT

Methods, computer-readable media, and systems are provided for machine learning in a simultaneous recurrent neural network. One embodiment of the invention provides a method including initializing one or more weight in the network, initializing parameters of an extended Kalman filter, setting a Jacobian matrix to an empty matrix, augmenting the Jacobian matrix for each of a plurality of training patterns, adjusting the one or more weights using the extended Kalman filter formulas, and calculating a network output for one or more testing patterns.

### FIELD OF INVENTION

The present invention generally relates to the fields of artificial intelligence and machine learning.

### BACKGROUND

Artificial neural networks (AANs), inspired by the enormous capabilities of living brains, are one of the cornerstones of today's field of artificial intelligence. Their applicability to real world engineering problems has become evident in recent decades. However, most of the networks used in the real-world applications use the feedforward architecture, which is a far cry from the massively recurrent architecture of the biological brains. The widespread use of feedforward architecture is facilitated by the availability of numerous efficient training methods. However, the introduction of recurrent elements makes training more difficult and even impractical for most nontrivial cases.

Simultaneous recurrent neural networks (SRNs) have been shown by several researchers to be more powerful function approximators. It has been shown experimentally that an arbitrary function generated by a multilayer perceptron (MLP) can always be learned by an SRN. However, the opposite was not true, as not all functions given by an SRN could be learned by an MLP.

It is known that MLPs and a variety of kernel-based networks (such as the radial basis function (RBF)) are universal function approximators, in some sense. Barron proved that MLPs are better than linear basis function systems like Taylor series in approximating smooth functions. A. R. Barron, Approximation and estimation bounds for artificial neural networks, 14(1) Mach. Learn. 115-33 (1994). More precisely, as the number of inputs to a learning system grows, the required complexity for an MLP only grows as O(N), while the complexity for a linear basis function approximator grows exponentially, for a given degree of accuracy in approximation. Id. However, when the function to be approximated does not live up to the usual concept of smoothness, or when the number of inputs becomes even larger than what an MLP can readily handle, it becomes ever more important to use a more general class of neural network (NN).

The area of intelligent control provides examples of very difficult functions to be tackled by ANNs. Such functions arise as solutions to multistage optimization problems, given by the Bellman optimality equation (“the Bellman equation”) provided herein as Equation (8). The design of nonlinear control systems, also known as “adaptive critics,” presupposes the ability of the so-called “critic network” to approximate the solution of the Bellman equation. Prokhorov provides an overview of adaptive critic designs. D. Prokhorov et al., Adaptive critic designs, 8(5) IEEE Trans. Neural Netw. 997-1007 (September 1997). Such problems also are classified as approximate dynamic programming (ADP). A simple example of such function is the 2-D maze navigation problem, considered in the “Description of the Invention” section herein. Pang and Werbos also provide an of the ADP and maze navigation problem. X. Pang & P. Werbos, Neural network design for J function approximation in dynamic programming, 2 Math Model. Sci. Comp. (1996) available at http://www.citebase.org/abstract?id=oai:arXiv.org:adap-org/9806001.

The classic challenge posed by Rosenblatt to perception theory is the recognition of topological relations. F. Rosenblatt, Principles Neural Dynamic (1962). Minsky and Papert have shown that such problems fundamentally cannot be solved by perceptrons because of their exponential complexity. M. L. Minsky & S. A. Papert, Perceptions (1969). The MLPs are more powerful than Rosenblatt's perceptron but they are also claimed to be fundamentally limited in their ability to solve topological relation problems. M. L. Minsky & S. A. Papert, Perceptions (Expanded ed. 1988). An example of such problem is the connectedness predicate. The task is to determine whether the input pattern is connected regardless of its shape and size.

The two previously described problems pose fundamental challenges to the new types of NNs, just like the XOR problem posed a fundamental challenge to the perceptrons, which could be overcome only by the introduction of the hidden layer and thus effectively moving to the new type of ANN.

### SUMMARY OF THE INVENTION

Methods, computer-readable media, and systems are provided for machine learning in a simultaneous recurrent neural network. One embodiment of the invention is directed to a method for machine learning in a simultaneous recurrent neural network. The method includes initializing one or more weight in the network, initializing parameters of an extended Kalman filter, setting a Jacobian matrix to an empty matrix, augmenting the Jacobian matrix for each of a plurality of training patterns, adjusting the one or more weights using the extended Kalman filter, and calculating network outputs for one or more testing patterns.

Embodiments of the invention may further include a variety of features. For example, the method can include terminating the method if a deviation between the solutions for the one or more testing patterns and the network output for the one or more testing patterns is within an acceptable range. The method may also include repeating the method if a deviation between the solutions for the one or more testing patterns and the network output for the one or more testing patterns is outside an acceptable range.

In some embodiments, the step of augmenting the Jacobian matrix for each of a plurality of training patterns includes the steps of running a forward update of the network with the training pattern, calculating a network output and a network error, backpropagating the network error through a network output transformation to produce one or more deltas, and backpropagating the one or more deltas through the network, thereby augmenting the Jacobian matrix.

In other embodiments, the step of adjusting the one or more weights using an extended Kalman filter includes the step of updating a state vector \vec{W} according to a Equation (4). The step of adjusting the one or more weights using an extended Kalman filter can include the step of updating a covariance matrix K̅ of the state vector \vec{W} according to Equation (5). R can be annealed according to Equation (6). The step of adjusting the one or more weights using an extended Kalman filter can include the step of setting values of matrix Q̅ to non-zero numbers.

Another embodiment of the invention is directed to a computer-readable medium whose contents cause a computer to perform a method for machine learning in a simultaneous recurrent neural network. The method includes initializing one or more weight in the network, initializing parameters of an extended Kalman filter, setting a Jacobian matrix to an empty matrix, augmenting the Jacobian matrix for each of a plurality of training patterns, adjusting the one or more weights using the extended Kalman filter, and calculating network outputs for one or more testing patterns.

Yet another embodiment of the invention is directed to a system including a computer-readable medium as described above and a computer in data communication with the computer-readable medium.

### FIGURES

For a fuller understanding of the nature and desired objects of the present invention, reference is made to the following detailed description taken in conjunction with the accompanying drawing figures wherein:

FIG. 1 depicts psuedocode for an algorithm for calculating ordered derivatives in an recurrent neural network (NN).

FIG. 2 depicts an architecture of a generic cellular simultaneous recurrent neural network (CSRN).

FIG. 3 depicts a generalized multilayer perceptron (GMLP) with m inputs and n outputs. The solid lines represent adjustable weights and the dashed lines represent unit weights. The output of the cell is scaled by the output weight.

FIG. 4 depicts an example of a 5×5 maze world. Black squares are obstacles. X is the location of the goal. The agent needs to find the shortest path from any white square to the goal.

FIG. 5 depicts a comparison of the solution given by an embodiment of the inventions described herein and the true solution. The location of the goal is indicated by the heavy bordered cell in the fifth column of the second row. Grid A depicts the approximate solution in which solid arrows indicate an incorrect suggestion. Grid B depicts the exact solution.

FIG. 6 depicts two examples of input patterns for a connectedness problem for a 7×7 image.

FIG. 7A is a graph of the average sum squared error for training on 30 mazes and testing on 10 mazes. The solid line represents the EKF training error. The dotted line represents the EKF testing error. The dashed line represents the ALR training error. The dashed-dotted line represents the ALR testing error. The 12.25 threshold for sum squared error is shown by a solid horizontal line.

FIG. 7B is a graph of the average goodness of navigation G for training 30 mazes and testing on 10 mazes. The solid line represents the EKF training goodness. The dotted line represents the EKF testing goodness. The dashed line represents the ALR training goodness. The dashed-dotted line represents the ALR testing goodness. The 50% solid line represents the goodness of a chance level network.

FIG. 8A depicts psueudocode for the training cycle of a CSRN according to one embodiment of the invention.

FIG. 8B depicts a flowchart for the training cycle of a CSRN according to one embodiment of the invention.

FIG. 9 depicts a simple feedforward network that can be divided into four blocks.

### DESCRIPTION OF THE INVENTION

The present invention provides a cellular simultaneous neural network (CSRN) architecture. Some embodiments of the invention are subsets of a more generic architecture, Object Net. Neurodynamics of Cognition & Consciousness 120 (L. I. Perlovsky & R. Kozma, eds. 2007). An extended Kalman filter (EKF) methodology is used for training the neural networks. For the first time, an efficient training methodology is applied to the complex recurrent network architecture. The invention herein addresses not only learning but also generalization of the network on two problems: maze and connectedness. Improvement in speed of learning by several orders of magnitude as a result of using EKF is also demonstrated.

### Backpropagation in Complex Networks

The backpropagation (BP) algorithm is the foundation of NN applications. P. Werbos, Backpropagation through time: What it does and how to do it, 78(10) Proc. IEEE 1550-60 (October 1990); P. Werbos, Consistency of HDP applied to a simple reinforcement learning problem, 3 Neural Netw. 179-89 (1990). BP relies on the ability to calculate the exact derivatives of the network outputs with respect to all the network parameters.

Real live applications often demand complex networks with large number of parameters. In such cases, the use of the rule of ordered derivatives allows the system to obtain the derivatives in systematic manner. P. Werbos, Backpropagation through time: What it does and how to do it, 78(10) Proc. IEEE 1550-60 (October 1990); L. Feldkamp & D. Prokhov, Phased backpropagation: A hybrid of temporal backpropagation and backpropagation through time, in Proc. World Congr. Comput. Intell. (1998). This rule also allows for the simplification of calculations by breaking a complex network into simple building blocks, each characterized by its inputs, outputs, and parameters. If the derivatives of the outputs of a simple building block with respect to all its internal parameters and inputs are known, then the derivatives of the complete system can be easily obtained by backpropagating through each block.

Suppose that the network consists of units, or subnetworks, which are updated in order from 1 to N. The derivatives of the network outputs with respect to the parameters of each unit are sought. In the general case, the final calculation for any network output is a simple summation

$$\frac{{\partial }^{+} {z}_{j}}{\partial α} = {\sum }_{i = 1}^{N} {\sum }_{k = 1}^{n} {δ}_{k}^{i} \frac{{\partial }^{+} {z}_{k}^{i}}{\partial α} \qquad ( 1 )$$

where α stands for any parameter, i is the unit number, k is the index of the output of the current unit, and δₖⁱ is the derivative with respect to the input of the unit that is connected to the kth output of the ith unit. Note that the kth output of the current unit can feed into several subsequent units and so the “delta” will be a sum of the “deltas” obtained from each unit. Also, δₖ^{N}'s are set externally as if the network were a part of a bigger system. If we simply want the derivatives of the outputs, we set δₖ^{N}=1. An example of this calculation is provided in the Appendix entitled “Calculating Ordered Derivatives” herein.

The outputs of the network are denoted as zᵢ. Ultimately, the derivatives of these outputs with respect to (w.r.t.) all the internal parameters are sought. This is equivalent to calculating the Jacobian matrix of the system. For example, given two outputs and three internal parameters and a, b, and c, the Jacobian matrix will be

$$\overline{C} = ( \begin{matrix}\frac{{\partial }^{+} {z}_{1}}{{\partial }_{a}} & \frac{{\partial }^{+} {z}_{1}}{{\partial }_{b}} & \frac{{\partial }^{+} {z}_{1}}{{\partial }_{c}} \\ \frac{{\partial }^{+} {z}_{2}}{{\partial }_{a}} & \frac{{\partial }^{+} {z}_{2}}{{\partial }_{b}} & \frac{{\partial }^{+} {z}_{2}}{{\partial }_{c}}\end{matrix} ) \qquad ( 2 )$$

This matrix can be used to adjust the system's parameters using various methods such as gradient descent or EKF.

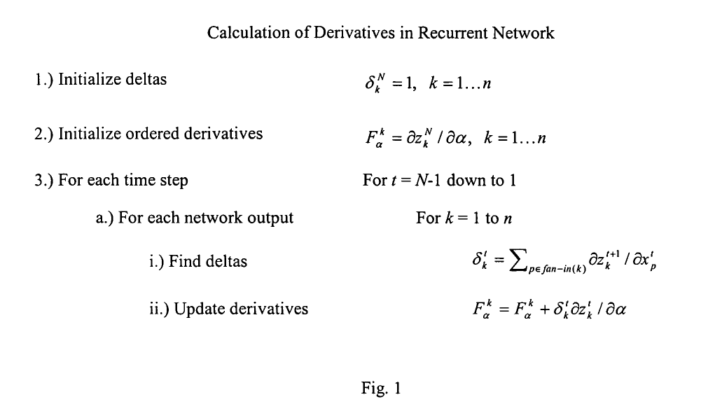

The foregoing discussion focused on multilayered feedforward networks. The methodology described previously can be extended to recurrent networks. Consider a feedforward network with recurrent connections that link some of its outputs to some of its inputs. Suppose that the network is updated for N steps and that the derivatives of the final network outputs w.r.t. the weights of the network are desired. This calculation is a case of Equation (1). Suppose that the network has m inputs and n outputs. Assume that the expressions for the derivatives of all outputs w.r.t. each input and each network weight ∂zₖ/∂α, k=1 . . . n, ∂zₖ/∂xₚ, k=1 . . . n, p=1 . . . m are known and that the ordered derivatives ∂+zₖ/∂α are denoted by F₆₀ ^{k}. Then, the full derivatives calculation is given by the algorithm in FIG. 1. Note that the loop over all the weight parameters is omitted to improve readability. The result of this algorithm is the Jacobian matrix of the network after iterations.

### Cellular Simultaneous Recurrent Networks

SRNs can be used for static functional mapping, similarly to the MLPs. They differ from more widely known time lagged recurrent networks (TLRNs) because the input in SRN is applied over many time steps and the output is read after the initial transitions have disappeared and the network is in equilibrium state. The most critical difference between TLRN and SRN is whether the network output is required at the same time step (TLRN) or after the network settles to an equilibrium (SRN).

Many real live problems require to process patterns that form a 2-D grid. For instance, such problems arise in image processing or in playing a game of chess. In those cases, the structure of the NN should also become a 2-D grid. If one makes all the elements of the grid identical, the resulting cellular NN benefits from greatly reduced number of independent parameters.

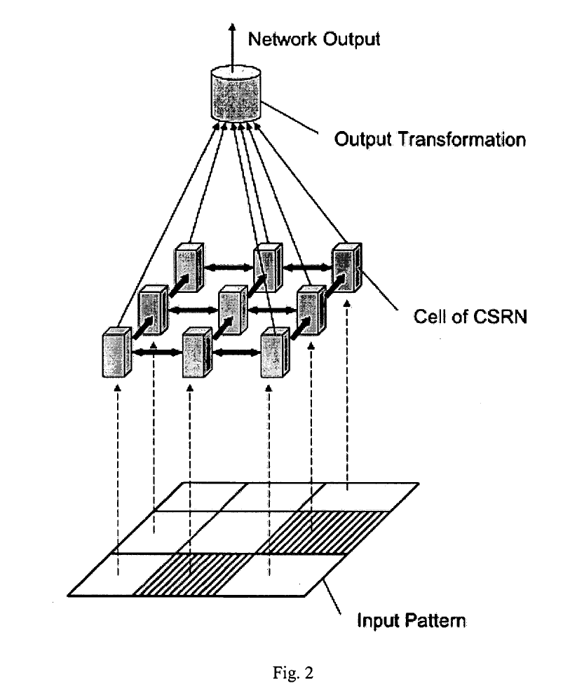

The combination of cellular structure with SRN creates very powerful function approximators. Embodiments of the present invention provide a CSRN package that can be easily adopted to various problems. The architecture of the network is given in FIG. 2. The input is always a 2-D grid. The number of cells in the network equals to the size of the input. The number of outputs also equals to the size of the input. Because many problems require only a few outputs, an arbitrary output transformation is added to the network in some embodiments. The arbitrary output transformation should be differentiable, but it does not require adjustable parameters. The training in embodiments of the invention occurs only in the SRN. The cells of the network are connected through neighbor links. Each cell has four neighbors and the edges of the network wrap around.

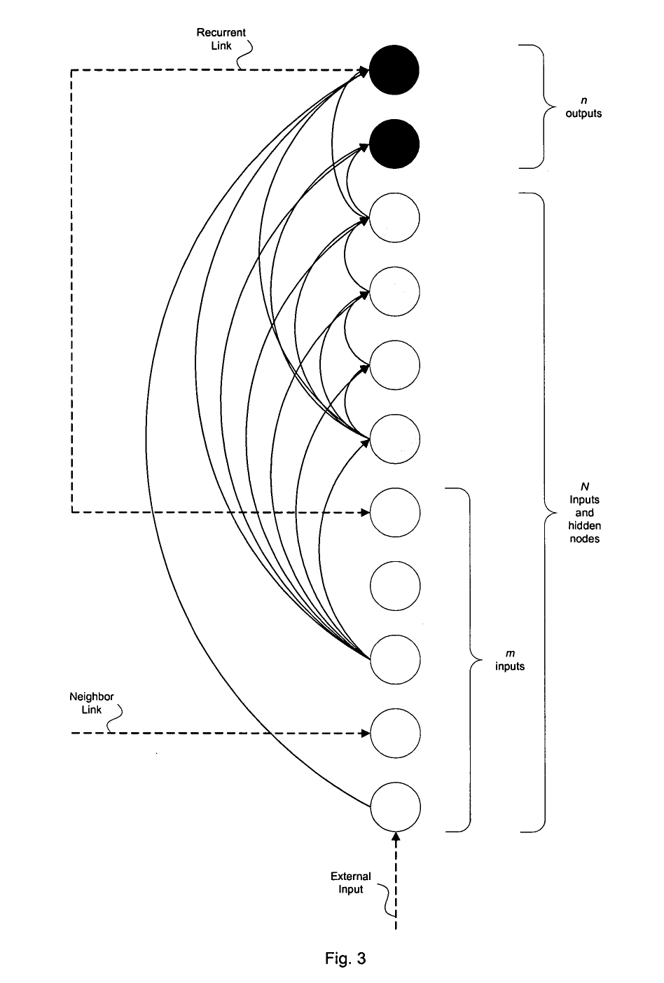

The cell of CSRN in this implementation is a generalized MLP (GMLP), shown in FIG. 3. P. J. Werbos, Handbook of Intelligent Control Neural, Fuzzy, & Adaptive Approaches (1992). Each noninput node of the GMLP is linked to all the subsequent nodes thus generalizing the idea of multilayered network. The recurrent connections come from the output nodes of this cell and from its neighboring cells. In some embodiments of the architecture, each cell has the same weights, which allows for the construction of arbitrary large networks without increasing the number of weight parameters.

### EKF for Network Training

Kalman filters (KF) originated in signal processing. They present a computational technique that allows to estimate the hidden state of a system based on observable measurements. Snyder and Forbes, as well as Anderson describe the derivation of the classical KF formulas based on the theory of multivariate normal distribution. See R. D. Snyder & C. S. Forbes, Understanding the Kalman filter: An object oriented programming perspective, 14/99 Monath Econometrics & Business Statistics Working Papers (1999); T. W. Anderson, An Introduction to Multivariate Statistical Analysis (1958).

In the case of NN training, a challenge is the problem of determining the parameter weights in such a way that the measured outputs of the network are as close to the target values as possible. The network can be described as a dynamical system with its hidden state vector \vec{W} formed by all the values of network weights, and the observable measurements vector formed by the values of network outputs \vec{Y}. It is sometimes convenient to form a full state vector \vec{S} that consists of both hidden and observable parts. Such formulation can be used in the derivation of K F. R. D. Snyder & C. S. Forbes, Understanding the Kalman filter: An object oriented programming perspective, 14/99 Monath Econometrics & Business Statistics Working Papers (1999). This application follows the convention of referring to \vec{W} as the state vector. See Kalman Filtering & Neural Networks (S. Haykin, ed. 2001). Note that the outputs of the network can be expressed in terms of the weights as

\vec{Y}= C̅\vec{W} (3)

where C̅ is the Jacobian matrix of the network evaluated around the current output vector \vec{Y}. It is assumed that the state \vec{S} is normally distributed and we are interested in the estimate of \vec{W} based on the knowledge of \vec{Y} and the underlying dynamical model of the system, which is simply \vec{Y}(i+1)=\vec{t} and \vec{W}(i+1)=\vec{W}(i), where \vec{t} is the target output of the network. Suppose the covariance matrix of \vec{W} is given by K̅, and the measurement noise covariance matrix is given by R̅. R̅ is assumed to be normally distributed with zero mean. Then, the Kalman update is given by

$$\begin{matrix}\vec{W} ( i + 1 ) = \vec{W} ( i ) + \frac{\overline{K} ( i ) {\overline{C} ( i )}^{T}}{\overline{C} ( i ) \overline{K} ( i ) {\overline{C} ( i )}^{T} + \overline{R} ( i )} ( \vec{t} - \vec{Y} ( i ) ) & ( 4 ) \\ \overline{K} ( i + 1 ) = \overline{K} ( i ) - \frac{\overline{K} ( i ) {\overline{C} ( i )}^{T} \overline{C} ( i ) \overline{K} ( i )}{\overline{C} ( i ) \overline{K} ( i ) {\overline{C} ( i )}^{T} + \overline{R} ( i )} + \overline{Q} ( i ) & ( 5 )\end{matrix}$$

The index is introduced to denote the current training step. The matrix Q̅(i) is the process noise covariance matrix. It represents assumptions about the distribution of the true values of \vec{W}. Equations (4) and (5) are the EKF formulas, which can be found in numerous literatures. See, e.g., L. Feldkamp et al., Enhanced multi-stream Kalman filter training for recurrent networks, in Nonlinear Modeling: Advanced Black-Box Techniques 29-53 (1998); Kalman Filtering & Neural Networks (S. Haykin, ed. 2001); S. Haykin, Neural Networks, A Comprehensive Foundation (1999). If one looks closely at Equation (4), the similarity between the EKF update and the regular gradient-descend update can be observed. In both cases, some matrix coefficient is multiplied by the difference (\vec{t}−\vec{Y}(i)). In the case of gradient descend, the coefficient is simply C̅(i) multiplied by some learning rate. In the case of EKF, the coefficient is more complex as it involves the covariance matrix K̅, which is the key to the efficiency of EKF.

The process noise Q̅ can be safely assumed to be 0, even though setting it to a nonzero value helps prevent K̅ from becoming negative definite and destabilizing the filter. The measurement noise R̅ also plays an important role in fine tuning of some embodiments of the EKF by accelerating the speed of learning. The proper functioning of EKF depends on the assumption that the state vector \vec{S} is normally distributed. This assumption usually does not hold in practice. However, adding the normally distributed noise described by R̅ helps overcome this difficulty. R̅ is usually chosen to be a random diagonal matrix. The values on the diagonal are annealed as the network training progresses, so that by the end of training, noise is insignificant. Experiments show that the way R is annealed has significant effect on the rate of convergence. After experimenting with different functional forms, the following formula was selected:

R(i)=a log(b\vec{δ}(i)²+1)I (6)

where δ(i)² is the squared error δ(i)=\vec{t}−\vec{Y}(i). The constants a and b were determined experimentally. The values a=b=0.001 were used which produced reasonably good results in the experiments discussed herein. This functional form works better than linear annealing. Making the measurement noise a function of the error results in fast and reliable learning.

Previous algorithms are suitable for learning one pattern. Learning multiple patterns creates additional challenges. The patterns can be learned by the algorithms described herein one by one or in a batch. In the experiments described herein, the batch mode is used for more efficient learning at the expense of additional computational resources. To explain this method, Equation (4) is rewritten more compactly as:

δ\vec{W}= G̅\vec{δ} (7)

where G̅= K̅ C̅^{T}/( C̅ K̅ C̅^{T}+ R̅) and the time-step index is omitted for clarity. The matrix G̅ is called Kalman gain.

Suppose that the network has s outputs and p weights. The size of matrix C̅ is s×p, and the size of G̅ is p×s. Suppose that there are M patterns in a batch. If the network is duplicated M times, the resulting network will have M×s outputs. The size of C̅ becomes M×s×p. Note that M matrices can be concatenated together. Matrix G̅ can still be computed from Equation (4) and its size becomes p×M×s. The weight update can be done just like in the case of one pattern, except now the matrix G̅ encodes information about all patterns.

This method is called multistreaming. See Kalman Filtering and Neural Networks (S. Haykin, ed. 2001); X. Hu et al., Time series prediction with a weighted bidirectional multi-stream extended Kalman filter, 70(13-15) Neurocomputing 2392-99 (2007). Increasing number of input patterns will result in large sizes of and C̅ and G̅. This will make batch update inefficient because of the need to invert large matrices. Therefore, larger problems can employ more advanced numerical techniques used by practitioners of EKF training. See, e.g., Kalman Filtering and Neural Networks (S. Haykin, ed. 2001); G. V. Puskorius & A. Feldkamp, Avoiding matrix invensions for the decoupled extended Kalman filter training algorithm, in Proc. World Congr. Neural Netw. I-764-69 (1995).

### CSRN Training Algorithm

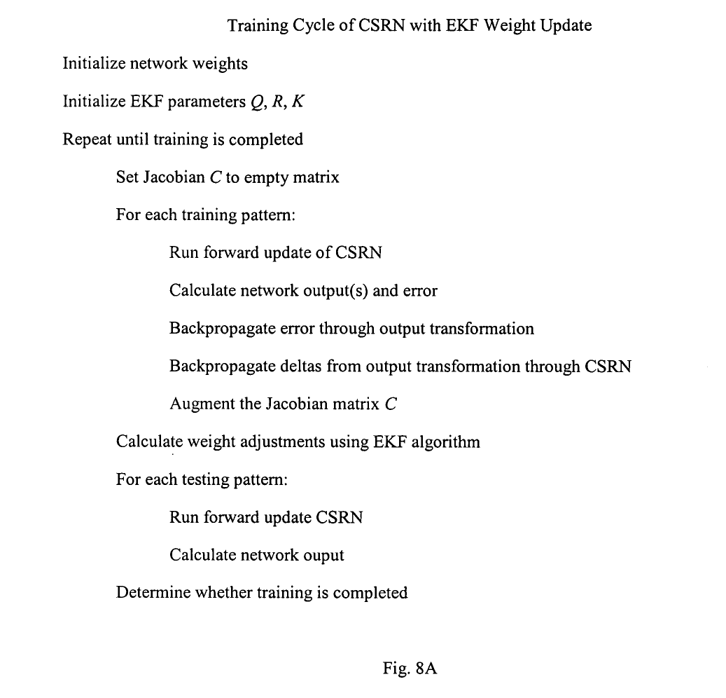

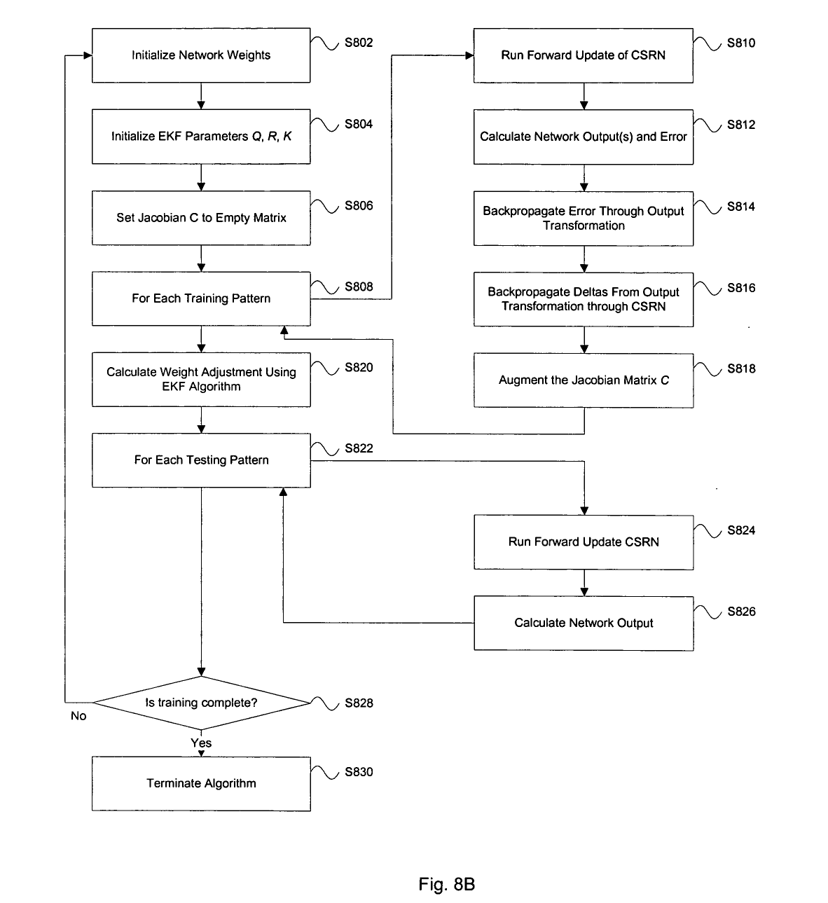

The network architecture given in FIG. 2 is very generic and with proper implementation can be easily adopted to different problems. The algorithm given in FIG. 8A and FIG. 8B describes the training of CSRN. The main loop calculates the Jacobian matrix C̅, which is used in the Kalman weight update. In some embodiments, testing is performed during each training period and a decision to stop training is made based on testing results. Output transformation is the part of the network customized for each problem. Other network parameters include network size, cell size, number of internal steps of SRN, EKF parameters K̅, R̅, and Q̅. The number of internal steps is selected large enough to allow the typical network to settle to an equilibrium state. In the process of training, the network dynamics changes and sometimes it no longer settles. In some embodiments, training is not terminated even if equilibrium is not reached as such networks still achieve good levels of generalization. The algorithms described herein can be implemented in a variety of programming languages including JAVA, C/C++, Matlab, and the like. A Matlab implementation is available from the Computational Dynamics Lab at the University of Memphis.

The algorithm depicted in FIG. 8A is described in greater detail in the context of FIG. 8B. In step S802, the network weights of \vec{W} are initiated. The network weights can be randomly selected or semi-randomly selected from a range of values tailored to reflect the network space for the particular application. In another embodiment, the multiple sets of network weights are generated and evaluated using the network. Evaluating multiple sets of network weights minimizes the likelihood of the algorithm focusing on local minima or maxima.

In step S804, EKF parameters Q̅, R̅, and K̅ are initialized. As discussed herein, process noise Q̅ can be assumed to 0. In other embodiments, Q̅ is set to nonzero value to prevent K̅ from becoming a negative definite and destabilizing the filter. R̅ is often chosen to be a random diagonal matrix.

In step S806, the Jacobian matrix C̅ is set to an empty matrix, i.e. a matrix having zero elements along each dimension.

A series of steps are conducted for each training pattern (S808). A forward update of the the CSRN is conducted (S810). Next, network output(s) and error are calculated (S812). The error is then backpropagated through the output transformation to produce deltas (S814), and the deltas are backpropogated through the CSRN (S816) to update the Jacobian matrix C (S816).

The weight adjustment for the network is calculated by the Extended Kalman Filter as described in Equations (4) and (5). The network is then tested using one or more testing patterns (S822). Each testing pattern is run forward through the network (S824) and the network output is calculated (S826). The difference between the solution to the pattern and the network output are compared (S828). If the difference is within the desired range, the algorithm is terminated. Otherwise, algorithm is reiterated from step S802.

### Application of EKF Learning to Generalized Maze Navigation Problem

### Problem Description

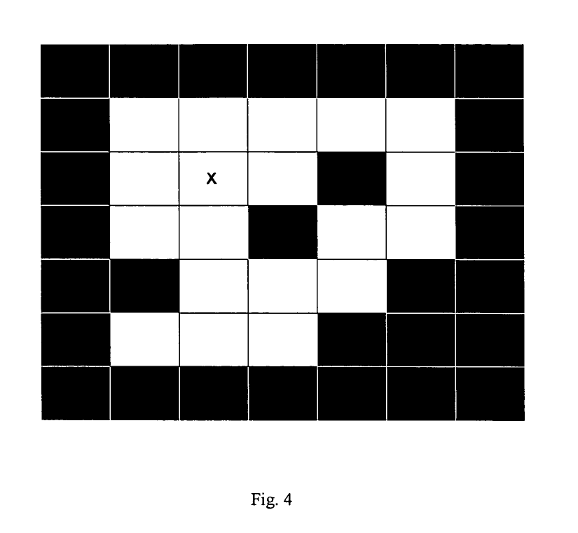

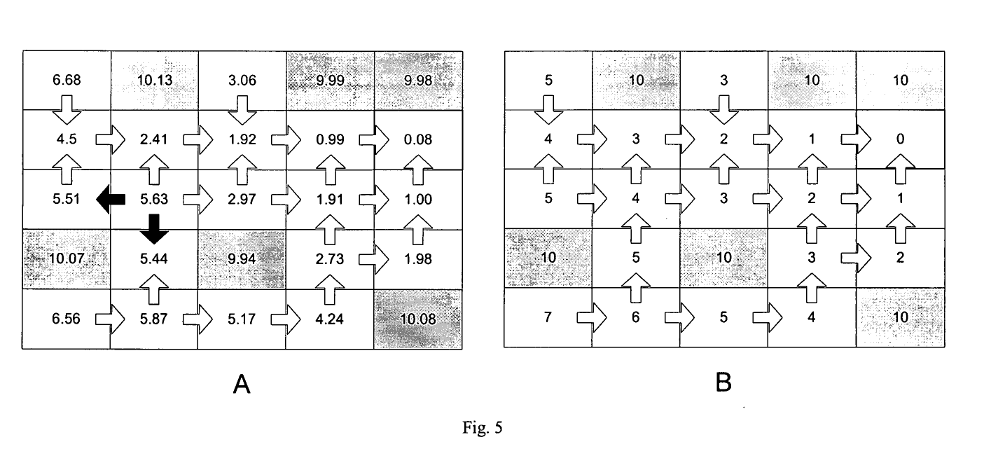

The generalized maze navigation consists of finding the optimal path from any initial position to the goal in a 2-D grid world. An example of such a world is illustrated in FIG. 4. One version of an algorithm for solving this problem will take a representation of the maze as its input and return the length of path from each clear cell to the goal. For example, for a maze the output will consist of 25 numbers. Once the numbers are designated, it is very easy to find the optimal path from any cell by simply following the minimum among the neighbors. Examples of such outputs are given in FIG. 5.

The 2-D maze navigation is a very simple representative of a broad class of problems solved using the techniques of dynamic programming, which means finding the J cost-to-go function using Bellman's equation. See, e.g., S. Haykin, Neural Networks, A Comprehensive Foundation (1999). Dynamic programming gives the exact solution to multistage decision problems. More precisely, given a Markovian decision process with N possible states and the immediate expected cost of transition between any two states i and j denoted by c(i,j), the optimal cost-to-go function for each state satisfies the following Bellman's optimality equation:

$${J}^{*} ( i ) = {min}_{μ} ( c ( i , μ ( i ) ) + γ {\sum }_{j = 1}^{N} {p}_{ij} ( μ ) {J}^{*} ( j ) ) \qquad ( 8 )$$

J(i) is the total expected cost from the initial state i, and γ is the discount factor. The cost J depends on the policy μ, which is the mapping between the states and the actions causing state transitions. The optimal expected cost results from the optimal policy μ*. Finding such policy directly from Equation (8) is possible using recursive techniques but computationally expensive as the number of states of the problem grows. In the case of the 2-D maze, the immediate cost c(i,j) is always 1, and the probabilities pᵢⱼ can only take values of 0 or 1.

The J surface resulting from the 2-D maze is a challenging function to be approximated by an NN. It has been shown that an MLP cannot solve the generalized problem [2]. P. J. Werbos & X. Pang, Generalized maze navigation: SRN critics solve what feedforward or Hebbian cannot, in Proc. Conf. Syst. Man Cybern. (1996). Therefore, this is a great problem to demonstrate the power of the CSRNs. It has been shown that CSRN is capable of solving this problem by designing its weights in a certain way [25]. D. Wunsch, The cellular simultaneous recurrent network adaptive critic design for the generalized maze problem has a simple closed-form solution, in Proc. Int. Joint Conf. Neural Netw. (2000). However, the challenge is to train the network to do the same.

The CSRN to solve the m×m maze problem consists of an (m+2)×(m+2) grid of identical units. The extra row and column on each side result from introducing the walls around the maze that prevent the agent from running away. Each unit receives input from the corresponding cell of the maze and returns the value of the function for this cell. There are two inputs for each cell: one indicates whether this is a clear cell or an obstacle and the other supplies the values of the goal. As shown in FIG. 2, the number of outputs of the cellular part of the network equals to the number of cells. In the maze application, the final output is the values of function for each input cell, and therefore, there is no need for the output transformation.

### Results of 2-D Maze Navigation

Previous results of training the CSRNs showed slow convergence. P. J. Werbos & X. Pang, Generalized maze navigation: SRN critics solve what feedforward or Hebbian cannot, in Proc. Conf. Syst. Man Cybern. (1996). Those experiments used BP with adaptive learning rate (ALR). Handbook of Intelligent Control Neural, Fuzzy, and Adaptive Approaches (D. A. White & D. A. Sofge, eds. 1992). The network consisted of five recurrent nodes in each cell and was trained on up to six mazes. The initial results demonstrated the ability of the network to learn the mazes. R. Ilin et al, Cellular SRN trained by extended Kalman filter shows promise for ADP, in Proc. Int. J. Conf. Neural Netw. 506-10 (2006).

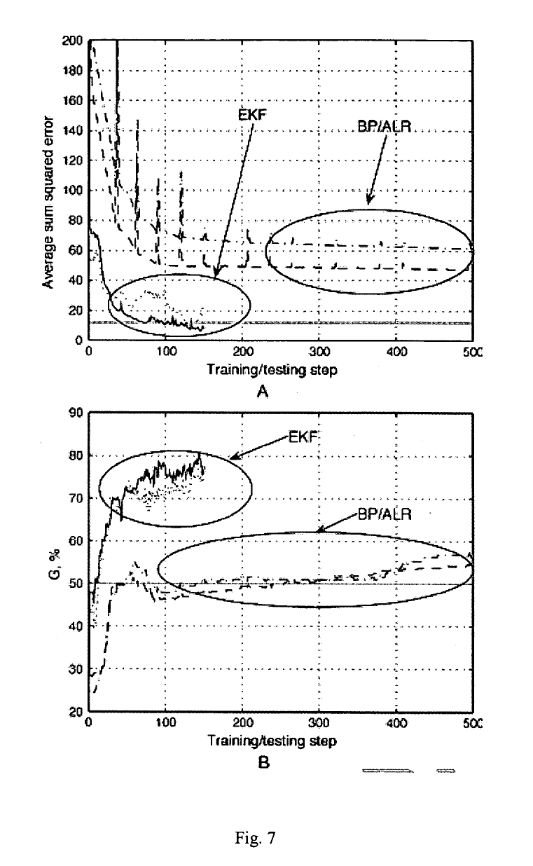

The introduction of EKF significantly sped up the training of the CSRN. In the case of a single maze, the network reliably converges within 10-20 training cycles (see FIG. 7). In comparison, BP through time with ALR requires between approximately 500 and 1000 training cycles and is more dependent on the initial network weights. P. J. Werbos & X. Pang, Generalized maze navigation: SRN critics solve what feedforward or Hebbian cannot, in Proc. Conf. Syst. Man Cybern. (1996).

Increasing the number of recurrent nodes from five to 15 allows to speed up both EKF and ALR training in case of multiple mazes. Nevertheless, the EKF has a clear advantage. For a more realistic learning assignment, 30 training mazes were used and the network was tested with ten previously unseen mazes. The training targets were computed using dynamic programming algorithm. FIG. 7A shows the sum squared error as a function of the training step. As depicted in FIG. 7A, EKF reached the reasonable level in 150 training cycles. For comparison, the BP through time with ALR training is shown on the same graph.

The true solution consists of integer values with the difference of one between the neighboring cells. For these experiments, an approximation is considered reasonable if the maximum error per cell is less than 0.5, since in this case, the correct differences will be preserved. This means that for a 7×7 network corresponding to a 5×5 maze, the sum squared error has to fall below 49×0.5²=12.25. In FIG. 7A, the EKF drops below the 12.25 level within 150 steps while ALR testing saturates at the level close to 50. Twenty (20) internal steps were used within each training cycle.

In practical training scenarios, the error is obviously not the same for each cell. Detailed statistical analysis can reveal the true nature of the expected distributions. The embodiments of the invention herein introduce an empirical measure of the goodness of learned navigation task in the following way. The number of gradients point in the correct direction is counted. The ratio of the number of correct gradients to the total number of gradients is the goodness ratio G that can vary from 0% to 100%. The gradient of the J function gives the direction of the next move. As an example, FIG. 5 shows the J function computed by a network and the true J function.

FIG. 5 demonstrates two erroneous gradient directions. The goodness G is illustrated in FIG. 7B. EKF reaches testing performance of 75%-80% after 150 training cycles averaged over ten testing mazes. On the other hand, BP/ALR testing performance lingers around 50% chance level for several hundred training cycles. Even after 500 training cycles, it is close to the chance level. This shows the potential of EKF for training CSRNs.

### Application of EKF to Connectedness Problem

### Simple Connectedness Problem

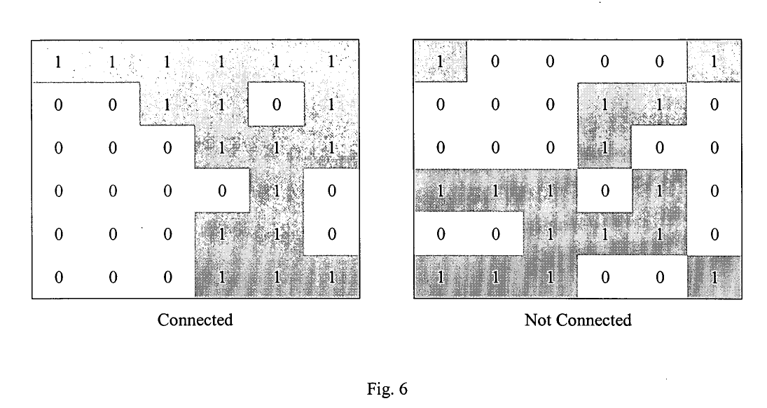

The description of connectedness problem can be found in M. L. Minsky & S. A. Papert, Perceptions (1969). The problem consists of answering the following question: Is the input pattern connected? Such question is fundamental to our ability to segment visual images into separate objects, which is the first preprocessing step before trying to recognize and classify the objects. This example considers a subset of the connectedness problem, which considers a square image and ask the following question: Are the top left and the bottom right corners connected? Note that the diagonal connections do not count in this example; each pixel of a connected pattern has to have a neighbor on the left, right, top, or bottom. Examples of such images are given in FIG. 6. This subset is still a difficult problem that could not be solved by the feedforward network. G. Burdet et al., Algorithms for the detection of connectedness and their neural implementation, in 7 Neuronal Information Processing: From Biological Data to Modelling and Applications (P. R. Roelfsema eds. 1999). The reason why connectedness is a difficult problem lies in its sequential nature. The human eye has to follow the borders of an image sequentially in order to classify it. This explains the need for recursion.

The network architecture for the connectedness problem is that of FIG. 2. The output transformation is a GMLP with one output. The weights of this GMLP are randomly generated and fixed. The target outputs are 0.5 for connected pattern and −0.5 for disconnected pattern.

### Results of Connectedness Problem

Embodiments of the invention were applied to image sizes 5, 6, and 7. In each case, sets of 30 random connected and 30 disconnected patterns were generated for training, along with ten connected and ten disconnected patterns for testing. Twenty (20) internal iterations were used within each training cycle and the training took between 100 and 200 training cycles. The same EKF parameters from the example of maze navigation described herein were used.

After training on 30 patterns, the network was tested and the percent of correctly classified patterns was calculated. The same set of patterns were applied to a feedforward network with one hidden layer. The size of the hidden layer varied to obtain the best results. The results are summarized in Table 1, where each number is averaged over ten experiments and the standard deviation is also given.

TABLE 1

| | Classification | Classification |
|---|---|---|
| Input Size | Performance for CSRN | Performance for MLP |
| 5 × 5 | 80 ± 6% | 66 ± 10% |
| 6 × 6 | 82 ± 6% | 65 ± 12% |
| 7 × 7 | 88.5 ± 6% | 63 ± 12% |

As seen in Table 1, the performance of MLP is just slightly above chance level whereas the CSRN trained in accordance with the methods provided herein produces correct answers in 80%-90% of test cases on previously unseen patterns. This performance can likely be improved by fine tuning network parameters.

### Additional Applications

Although the embodiments described here utilize a GMLP, any other feedforward computation suitable for the problem at hand can be substituted for the GMLP without any changes to the CSRN. Accordingly, it is practical to use the proposed combination of architecture and the training method to any data that has 2-D grid structure. The network size does not grow exponentially with the input size because of the weight sharing. The input pattern could be processed by the CSRN with 15 units in each cell. However, large networks still involve massive computations, which can be addressed by efficient hardware implementations. T. Yang & L. O. Chuam, Implementing back-propagation through-time learning learning algorithm using cellular neural networks, 9(6) Int. J. Bifurcation Chaos 1041-77 (1999).

One example of such application is image processing. Detecting connectedness is a fundamental challenge in this field. As demonstrated above, CSRN was applied to a subset of connectedness problem with minimal changes to the code. The results showed that CRSN is much better at recognizing connectedness compared to feedforward architecture.

Another example of such data is the board games. The games of chess and checkers have long been used as testing problems for artificial intelligence (AI). Recently, NNs coupled with evolutionary training methods have been successfully applied to the games of checkers and chess. D. B. Fogel & K. Chellapilla, Evolving an expert checkers playing program without using human expertise, 5(4) IEEE Trans. Evolut. Comput. 422-28 (August 2001); D. B. Fogel et al., A self-learning evolutionary chess program, 92(12) Proc. IEEE 1947-54 (December 2004). The NN architecture used in those works is the case of Object Net. Neurodynamics of Cognition & Consciousness (L. I. Perlovsky & R. Kozma eds. 2007). The input pattern (the chess board) is divided into spacial components and the network is built with separate subunits receiving input from their corresponding components. The interconnections between the subunits of the network encode the spacial relationships between different parts of the board. The outputs of the Object Net feed into another multilayered network using to evaluate the overall “fitness” of the current situation on the board.

As demonstrated herein, the CSRN network is a simplified case of the Object Net. The chess Object Net belongs to the same class of multistage optimization problems, even though it does not presently use recurrent units. The biggest difference, however, is the training method. The evolutionary computation has proven to be able to solve the problem, but at high computational cost. The inventions described herein provide an efficient training method for the Object-Net-type of networks with more biologically plausible training using local derivatives information. Object Nets are a type of SRN in which a plurality of objects are used for cells. Object Nets are described in U.S. Pat. No. 6,708,160 to Werbos. The improved efficiency allows the use of SRNs, which are proven to be more powerful in function approximation than the MLPs. Therefore, the CSRN/EKF can be applicable to many interesting problems.

One skilled in the art will readily recognize that the method described herein can be implemented on computer readable media or a system. An exemplary system includes a general purpose computer configured to execute the methods described herein.

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### Incorporation by Reference

The entire contents of all patents, published patent applications, and other references cited herein are hereby expressly incorporated herein in their entireties by reference.

### Appendix: Calculating Ordered Derivatives

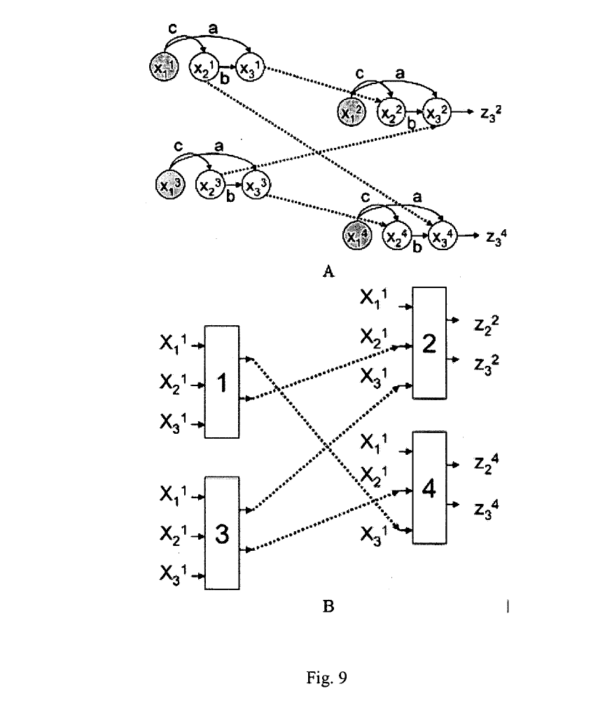

The following example is an illustration of the principles mentioned herein. Consider the network in FIG. 9(a). This network can be decomposed into four identical units as shown in FIG. 9(b), where each unit is a mapping between its inputs, internal parameters, and outputs. This is a case of a simple recurrent cellular network with two cells and two iterations. The recurrent steps are unfolded to demonstrate the application of the rule of ordered derivatives.

Each unit has three inputs x₁, x₂, and x₃ and three parameters a, b, and c. The outputs of each neuron are denoted by z₁, z₂, and z₃. The first input neuron does not perform any transformation, so z₁=z₂. The second and third neurons use a nonlinear transformation f. The forward calculation of an elementary unit is as follows:

z₂=x₂+f(cx₁) (A-1)

z₃=x₃+f(ax₁+bz₂) (A-2)

The order in which different quantities appear in the forward calculation is

x₁,x₂,x₃,c,z₂, a,b,z₃ (A-3)

The rule of ordered derivatives is applied to determine the derivatives of z₂ and z₃ w.r.t. the inputs and parameters. P. Werbos, Backpropagation through time: What it does and how to do it, 78(10) Proc. IEEE 1550-60 (October 1990). The rules of ordered derivatives is given by

$$\frac{{\partial }^{+} TARGET}{\partial {z}_{i}} = \frac{\partial TARGET}{\partial {z}_{i}} + {\sum }_{j = i + 1}^{N} \frac{{\partial }^{+} TARGET}{\partial {z}_{j}} \frac{\partial {z}_{j}}{\partial {z}_{i}} \qquad ( A \text{-} 4 )$$

where TARGET is the variable the derivative of which w.r.t. is sought, and the calculation of TARGET involves using zⱼ's in order of their subscripts. The notation ∂⁺ is used for the ordered derivative, which simply means the full derivative, as opposed to a simple partial derivative obtained by considering only the final equation involving TARGET.

In order to calculate the derivatives in our example, Equation (A-4) is used in reverse order of Equation (A-3). Let φ denote the derivative of f

$$\begin{matrix}\frac{{\partial }^{+} {z}_{3}}{\partial b} = \frac{\partial {z}_{3}}{\partial b} = {z}_{2} φ ( {ax}_{1} + {bz}_{2} ) & ( A \text{-} 5 ) \\ \frac{{\partial }^{+} {z}_{3}}{\partial a} = \frac{\partial {z}_{3}}{\partial a} = {z}_{1} φ ( {ax}_{1} + {bz}_{2} ) & ( A \text{-} 6 ) \\ \frac{{\partial }^{+} {z}_{3}}{\partial {z}_{2}} = \frac{\partial {z}_{3}}{\partial {z}_{2}} = b φ ( {ax}_{1} + {bz}_{2} ) & ( A \text{-} 7 ) \\ \frac{{\partial }^{+} {z}_{3}}{\partial c} = \frac{{\partial }^{+} {z}_{3}}{\partial {z}_{2}} \frac{{\partial }^{+} {z}_{2}}{\partial c} = b φ ( {ax}_{1} + {bz}_{2} ) {x}_{1} φ ( {cx}_{1} ) & ( A \text{-} 8 ) \\ \frac{{\partial }^{+} {z}_{3}}{\partial {x}_{3}} = \frac{\partial {z}_{3}}{\partial {x}_{3}} = 1 & ( A \text{-} 9 ) \\ \frac{{\partial }^{+} {z}_{3}}{\partial {x}_{2}} = \frac{{\partial }^{+} {z}_{3}}{\partial {z}_{2}} \frac{\partial {z}_{2}}{\partial {x}_{2}} b φ ( {ax}_{1} + {bz}_{2} ) & ( A \text{-} 10 ) \\ \frac{{\partial }^{+} {z}_{3}}{\partial {x}_{1}} = \frac{{\partial }^{+} {z}_{3}}{\partial {z}_{2}} \frac{\partial {z}_{2}}{\partial {x}_{1}} = b φ ( {ax}_{1} + {bz}_{2} ) c φ ( {cx}_{1} ) & ( A \text{-} 11 ) \\ \frac{{\partial }^{+} {z}_{2}}{\partial c} = \frac{\partial {z}_{2}}{\partial c} = {x}_{1} φ ( {cx}_{1} ) & ( A \text{-} 12 ) \\ \frac{{\partial }^{+} {z}_{2}}{\partial {x}_{3}} = \frac{\partial {z}_{2}}{\partial {x}_{3}} = 0 & ( A \text{-} 13 ) \\ \frac{{\partial }^{+} {z}_{2}}{\partial {x}_{2}} = \frac{\partial {z}_{2}}{\partial {x}_{2}} = 0 & ( A \text{-} 14 ) \\ \frac{{\partial }^{+} {z}_{2}}{\partial {x}_{1}} = \frac{\partial {z}_{2}}{\partial {x}_{1}} = c φ ( {cx}_{1} ) & ( A \text{-} 15 )\end{matrix}$$

Knowing these derivatives, the derivatives of the full network can be calculated. A superscript is added to each variable indicating which unit of the network it belongs to. Note that the outputs of the earlier unit become the inputs of the later unit. Consider unit 2, which gets input from units 1 and 3. If we apply Equation (A-4) to obtain the derivative of, for example, z₃² w.r.t. a, the following result is obtained, based on the topology of connections between the units:

$$\frac{{\partial }^{+} {z}_{3}^{2}}{\partial a} = \frac{{\partial }^{+} {z}_{3}^{2}}{\partial {a}^{2}} + \frac{{\partial }^{+} {z}_{3}^{2}}{\partial {z}_{3}^{3}} \frac{{\partial }^{+} {z}_{3}^{3}}{\partial {a}^{3}} + \frac{{\partial }^{+} {z}_{3}^{2}}{\partial {z}_{2}^{1}} \frac{{\partial }^{+} {z}_{2}^{1}}{\partial {a}^{2}} \qquad ( A \text{-} 16 )$$

a²=a³=a because identical units are used. The quantities ∂^{30 z}₂¹/∂a² and ∂³⁰z₃³/∂a³ are already obtained for each unit. Since z₂¹=x₃² and z₃³=x₂², the quantities ∂⁺z₃²/∂z₂¹ and ∂³⁰ z₃²/∂z₃² are equivalent to ∂³⁰ z₃²/∂z₃² and ∂z⁺z₃²/∂z₂², which are also already calculated for each individual unit. They are the input “deltas,” or the output derivatives “propagated” through the unit backwards. In other words, when all the quantities of each individual unit are calculated, then the total derivatives of the outputs of the full network w.r.t. any parameter are obtained by summing the individual unit's derivative multiplied by the corresponding “delta.” The correspondence is determined by the topology of connections—knowing which output is connected to which input. Every time the process backpropagates through a unit, the process also sets the values of the “deltas” of preceding units. In this example

$$\begin{matrix}{δ}_{2}^{2} = \frac{{\partial }^{+} {z}_{3}^{2}}{\partial {z}_{2}^{1}} = \frac{{\partial }^{+} {z}_{3}^{2}}{\partial {x}_{3}^{2}} & ( A \text{-} 17 ) \\ {\partial }_{3}^{2} = \frac{{\partial }^{+} {z}_{3}^{2}}{\partial {z}_{3}^{2}} = \frac{{\partial }^{+} {z}_{3}^{2}}{\partial {x}_{2}^{2}} & ( A \text{-} 18 ) \\ \frac{{\partial }^{+} {z}_{3}^{2}}{\partial a} = \frac{{\partial }^{+} {z}_{3}^{2}}{\partial {a}^{2}} + {δ}_{3}^{2} \frac{{\partial }^{+} {z}_{3}^{3}}{\partial {a}^{3}} + {δ}_{2}^{2} \frac{{\partial }^{+} {z}_{2}^{1}}{\partial {a}^{2}} & ( A \text{-} 19 )\end{matrix}$$

Likewise, in a general case, the final calculation for any network output j is a simple summation given by Equation (1).

1. A method for machine learning in a simultaneous recurrent neural network, the method comprising:
initializing one or more weight in the network;
initializing parameters of an extended Kalman filter;
setting a Jacobian matrix to an empty matrix;
augmenting the Jacobian matrix for each of a plurality of training patterns;
adjusting the one or more weights using the extended Kalman filter; and
calculating network outputs for one or more testing patterns.

2. (canceled)

3. (canceled)

4. The method of claim 1 wherein the step of augmenting the Jacobian matrix for each of a plurality of training patterns comprises the steps of:
running a forward update of the network with the training pattern;
calculating a network output and a network error;
backpropagating the network error through a network output transformation to produce one or more deltas; and
backpropagating the one or more deltas through the network, thereby augmenting the Jacobian matrix.

5. The method of claim 1, wherein the step of adjusting the one or more weights using an extended Kalman filter comprises the step of:
updating a state vector \vec{W} according to a formula
$$\vec{W} ( i + 1 ) = \vec{W} ( i ) + \frac{\overline{K} ( i ) {\overline{C} ( i )}^{T}}{\overline{C} ( i ) \overline{K} ( i ) {\overline{C} ( i )}^{T} + \overline{R} ( i )} ( \vec{t} - \vec{Y} ( i ) ) .$$

6. The method of claim 5, wherein the step of adjusting the one or more weights using an extended Kalman filter further comprises the step of:
updating a covariance matrix K̅ of the state vector \vec{W} according to a formula
$$\overline{K} ( i + 1 ) = \overline{K} ( i ) - \frac{\overline{K} ( i ) {\overline{C} ( i )}^{T} \overline{C} ( i ) \overline{K} ( i )}{\overline{C} ( i ) \overline{K} ( i ) {\overline{C} ( i )}^{T} + \overline{R} ( i )} + \overline{Q} ( i ) .$$

7. (canceled)

8. The method of claim 6, wherein the step of adjusting the one or more weights using an extended Kalman filter further comprises the step of:
setting values of matrix Q̅ to non-zero numbers.

9. A computer-readable medium whose contents cause a computer to perform a method for machine learning in a simultaneous recurrent neural network, the method comprising:
initializing one or more weight in the network;
initializing parameters of an extended Kalman filter;
setting a Jacobian matrix to an empty matrix;
augmenting the Jacobian matrix for each of a plurality of training patterns;
adjusting the one or more weights using the extended Kalman filter; and
calculating network outputs for one or more testing patterns.

10. A system comprising:
a computer-readable medium as recited in claim 9; and
a computer in data communication with the computer-readable medium.

11. The method of claim 1, wherein the method is a computer-implemented method.
